(19) United States
(12) Patent Application Publication
(10) Pub. No.: US 2024/0338459 A1
(43) Pub. Date: Oct. 10, 2024

(54) AUTOMATIC ANALYSIS OF THE EXPLOITABILITY OF VULNERABILITIES OF A SOFTWARE IMAGE

(71) Applicant: Siemens Aktiengesellschaft, München (DE)

(72) Inventors: Klaus Lukas, München (DE); Christian Knierim, München (DE)

(21) Appl. No.: 18/700,016

(22) PCT Filed: Sep. 26, 2022
(86) PCT No.: PCT/EP2022/076648

§ 371 Date: Apr. 10, 2024

(30) Foreign Application Priority Data
Oct. 15, 2021 (DE) 10 2021 211 676.0
Oct. 27, 2021 (EP) 21204907.6

(51) Int. Cl. G06F 21/57

(52) U.S. Cl. CPC G06F 21/577; G06F 2221/033

(57) ABSTRACT

A method for automatically analyzing the exploitability of vulnerabilities of a software image executed on a target computer is provided, including: identifying all the software components contained in the software image, determining vulnerabilities of the identified software component for each software component of the software image using a vulnerability database, determining all exploits associated with the at least one determined vulnerability of the software component, for each identified software component, using an exploit database associating the determined exploits with the software image, and executing the software image and the exploit associated with the software image on a configuration of an execution environment specific to the target computer, and confirming the exploitability of the at least one identified vulnerability on the specific configuration of the execution environment if the execution of the at least one exploit leads to exploitation of the vulnerability.

### CROSS-REFERENCE TO RELATED APPLICATIONS

This application claims priority to PCT Application No. PCT/EP2022/076648, having a filing date of Sep. 26, 2022, which claims priority to EP Application No. 2124907.6, having a filing date of Oct. 27, 2021, and DE Application No. 10 2021 211 676.0, having a filing date of Oct. 15, 2021, the entire contents all of which are hereby incorporated by reference.

### FIELD OF TECHNOLOGY

The following relates to methods for the automatic analysis of the exploitability of vulnerabilities of a software image executed on a target computer.

### BACKGROUND

A software image refers to an image of a software program that comprises all components of the software program. In addition to an application program, components of the software program include, for example, software libraries or binaries that are called and executed when the application program is run. The software image can be executed directly on a runtime environment of a computer. Software images can also be created and run as a container image encapsulated using container virtualization, for example in cloud environments. In the following, the abbreviation SW is used synonymously for the word software for better readability.

Container virtualization is a method in which multiple instances of an operating system can use an operating system kernel of a guest computer in isolation from one another. Software containers, hereafter referred to as containers for short, thus represent a lightweight type of virtualization of a runtime environment on a guest computer, also termed a host system, and encapsulate an application operated in a container from the underlying host system. Software applications are now implemented in many areas by containers, for example in industrial automation and process control, but also in transport systems or building automation.

In order to start a container on the host system, a container image is required which, in addition to the application software itself, also contains the binaries and libraries required for the application software. A container, more precisely a container instance, is created on the host system from the container image and executed in the runtime environment of the host system.

The software composition of the container instances remains unchanged throughout the runtime. The same applies to SW applications on non-containerized devices that are installed via pre-built SW images, the configuration and composition of which no longer change after the installation. Examples include e.g., cloud instances, which are usually not patched, but instead are created from scratch using new operating system images. Other examples include devices such as switches or firewalls, on which a ready-made firmware is installed. The firmware is usually not patched, rather the software version is installed by importing the firmware package.

Although the SW image is always loaded onto a runtime environment of the devices with the same SW components, all software components do not always need to be activated in the runtime environment. This may be due to different configurations of the runtime environment, such as license keys, that do not allow the use of certain components.

US 2017/0109536 A1 discloses a method for detecting vulnerabilities in a base image of software containers. Upon receipt of an event, the content of the base image is extracted and a detection event is generated if a vulnerability is found.

U.S. Pat. No. 9,400,889 B2 discloses a method for automatically analyzing the exploitability of vulnerabilities of a piece of source code or executable code of a software program. An attack management module uses static analysis to identify potential vulnerabilities in the code. A fault injection engine processes the identified vulnerabilities to apply vulnerability tests to the software. The fault injection engine systematically tests vulnerable parts of the code for known and customized attacks. For example, it will use exploits against input fields, cookies, headers and the like. The performance of the code under these conditions is then analyzed and the results are communicated to the user.

CN 111 259 406 A discloses the creation of a container image containing a software image to be analyzed and exploits to be applied to the software image. The container image is then executed in a runtime environment to determine whether the software image under analysis is vulnerable to the exploits.

US 2016/314302 A1 discloses the execution of a container image in various configurations of a runtime environment of a target machine. Exploits are then injected into the container to find out in which configuration of the runtime environment the container image is vulnerable to attack by the exploits.

This creates the problem that vulnerabilities and thus security holes of a software image may well be known, but it is not known whether these known security holes can also be exploited in the runtime environment of a specific device.

### SUMMARY

An aspect relates to a method in which the exploitability of a SW image installed on a specific target device can be determined and replaced quickly and with little effort.

According to a first aspect, embodiments of the invention relate to a method for the automatic analysis of the exploitability of vulnerabilities of a software image executed on a target computer, comprising
identifying all the software components contained in the SW image,
determining vulnerabilities of the identified software component for each SW component of the SW image using a vulnerability database,
determining all exploits associated with the at least one determined vulnerability of the software component, for each identified SW component, using an exploit database,
associating the determined exploits with the software image, and
executing the SW image and the exploit associated with the SW image on a runtime environment configuration specific to the target computer,
confirming the exploitability of the at least one identified vulnerability on the specific configuration of the runtime environment if the execution of the at least one exploit leads to exploitation of the vulnerability, wherein a modified, non-exploitable software image is created depending on a policy stored in a manufacturer's assembly device for assembling the software image and depending on the at least one confirmed exploitable vulnerability, and the modified software image is provided to one or all of the target computers that have the specific configuration of the runtime environment.

In electronic data processing, an exploit is a systematic exploiting vulnerabilities that have arisen during the development of a program. The exploit includes program code that, when applied to the software component, exploits vulnerabilities, for example security holes and malfunctions of programs, in this case of the software component, usually in order to gain access to resources or to penetrate or impair the target computer. This means that all vulnerabilities and the exploits necessary to check the exploitability of the vulnerabilities can be systematically assembled for a given software image. This enables a selective checking of the exploitability of the vulnerabilities of the SW image on the runtime environment of the target computer on which the SW image was installed. If a SW component of the SW image affected by a vulnerability is not activated on the runtime environment configuration specific to the target computer and is therefore not executed, then the vulnerability in this runtime environment configuration specific to the target computer cannot be exploited. The SW image can be executed without security issues. Thus, only those vulnerabilities that can actually be used for security holes and malfunctions of the software component on the target computer-specific configuration of the runtime environment are confirmed as exploitable.

In an embodiment, the at least one exploitable vulnerability is reported to a user of the target computer and/or to a manufacturer of the SW image.

In an embodiment, the method only reports those cases that are actually problematic for the individual target computer to the user of the target computer or the manufacturer of the SW image.

In an embodiment, the method steps are carried out after assembly of the software image at the manufacturer and/or at predetermined time intervals and/or after predetermined events.

By carrying out the method after assembly of the SW image, the manufacturer can be alerted, for example, that the SW image contains vulnerabilities in the configuration of the runtime environment of the target computer and that these are exploitable, and an update of the software image can be triggered automatically. After predetermined events, such as availability of a new version or patches of the SW image, an exploitability check can be carried out automatically for the target computer-specific configuration of the runtime environment and the new version can only be imported if no exploitable vulnerability is reported.

In an embodiment, a modified, non-exploitable SW image is created depending on a policy stored in a manufacturer's assembly device for assembling the SW image and depending on the at least one confirmed exploitable vulnerability.

The policy stored in the assembly device, also called a build system, allows the confirmed exploitable vulnerabilities to be systematically eliminated and a modified SW image to be created in which the identified and exploitable vulnerabilities are either removed or not exploitable. The policy allows the modified SW image to be created completely or at least partially automatically.

In an embodiment, the modified SW image is provided, in particular on a software repository, and automatically imported into the target computer.

This means that the modified SW image can be installed automatically on the target computer as a published patch.

In an embodiment, the modified SW image is provided, in particular on a software repository, and the modified SW image is automatically imported into further target computers with the same specific configuration of the runtime environment.

This means that not only one target system, but all, or at least other target systems with the same configuration of the runtime environment, can be updated and thus protected against attacks. An analysis of the exploitability does not need to be performed again for the other target systems.

In an embodiment, the SW components and their vulnerabilities are identified on a reference computer or on a manufacturer's assembly device.

The advantage of identifying the SW components on the assembly device is that information on the SW components contained in the SW image is available quickly and with little or no additional effort. Furthermore, a list of the SW components and their vulnerabilities can be provided with each released SW image. The advantage of performing the determination on a reference computer is that it is carried out before the software image is actually installed on the target computer.

In an embodiment, the SW components are identified depending on a signature of the SW component or by a package manager within the SW image.

The package manager is usually included in a SW image, so that hardly any modifications or additional effort are required for the identification. Identification based on the signature of the SW component is reliable and also enables an integrity check of the SW component.

In an embodiment, additional manufacturing information, in particular a version identifier, is determined for the at least one identified SW components.

This enables a distinction to be made between different variants of the SW component and the vulnerabilities known for this variant to be assigned more quickly.

In an embodiment, a vulnerability profile specific to the SW image and comprising the identified SW components, the determined vulnerabilities and the determined exploits, is stored on an image vulnerability database.

If the SW image is installed on another target computer, the exploitability of the SW image can be checked on the configuration specific to the further target computer by retrieving the SW image-specific vulnerability profile from the image vulnerability database without determining the software components, vulnerabilities and exploits again. This enables an efficient exploitability check in terms of time and computing capacity.

In an embodiment, different configurations of runtime environments, with the correspondingly configured target computers on which the SW image is executed, are determined by an inventory database.

This means that the different configurations of runtime environments can be easily determined and the exploitability of the vulnerabilities of the SW image can be checked on the present configuration before installation or during the runtime of the SW image. In the inventory database, the individual target computers configured accordingly are also associated with and saved to the configuration of the runtime environments.

In an embodiment, the configuration of the runtime environment of the target computer on which the SW image is executed is determined by the target computer and transmitted to an inventory database.

This is, for example, determined with an additional function, for example in the form of a plugin, or by an agent operated on the target computer in the runtime environment. This means that the target computer can independently report its configuration to the runtime environment.

In an embodiment, the configuration of the runtime environment of the target computer on which the SW image is executed is determined by a target computer and transmitted to the inventory database.

This means that the configuration of the runtime environment can also be determined by target computers without an agent or plugin. Target computers do not need to be extended, or non-extendable target computers can still be recorded in the inventory database.

In an embodiment, the configuration scanner determines the configuration of the runtime environment of the target computer depending on open services on the target computer, response messages of the target computer to queries directed to the target computer, or an identifier of the target computer.

According to a further aspect, embodiments of the invention relate to a system for automatic analysis of the exploitability of vulnerabilities of a software image executed on a target computer, comprising an analysis unit which is designed to
identify all software components contained in the SW image,
determine vulnerabilities of the identified software component for each SW component of the SW image using a vulnerability database,
determine all exploits associated with the at least one identified vulnerability of the software component, for each identified software component, using an exploit database, and
associate the determined exploits with the software image, and a verification unit, which is designed to a test unit which is designed to
execute the SW image and the exploit associated with the SW image on a configuration of the runtime environment specific to the target computer,
confirm the exploitability of the identified vulnerabilities on the specific configuration of the runtime environment if the execution of the at least one exploit leads to exploitation of the vulnerability, and
to report the exploitable vulnerabilities to a user of the target computer and/or to a manufacturer of the SW image, wherein a modified, non-exploitable software image is created depending on a policy stored in a manufacturer's assembly device for assembling the software image and depending on the at least one confirmed exploitable vulnerability, and the modified software image is provided to one or all of the target computers that have the specific configuration of the runtime environment.

In one embodiment, the system additionally comprises an image vulnerability database, which is designed to store a SW image-specific vulnerability profile comprising the identified SW components, the determined vulnerabilities and the determined exploits.

The system according to embodiments of the invention can be used to carry out an automatic exploitability test, i.e., it can be checked whether identified vulnerabilities can actually be used for an attack on the target computer with the specific configuration of its runtime environment.

A further aspect of embodiments of the invention relates to a computer program product (non-transitory computer readable storage medium having instructions, which when executed by a processor, perform actions), comprising a non-volatile computer-readable medium which can be loaded directly into a memory of a digital computer, comprising program code parts which when they are executed by the digital computer cause the computer to carry out the steps of the method.

Unless otherwise specified in the description below, the terms “determine”, “associate”, “execute”, “confirm”, “report” and the like, for example, refer to actions and/or processes and/or processing steps that modify and/or generate data and/or convert the data into other data, wherein the data is or may be in particular in the form of physical quantities, for example electrical pulses. The system and components optionally contained in it, such as an image vulnerability database, a vulnerability database, an exploit database, an inventory database, target computers and the like may comprise one or more processors. In particular, a processor may be a main processor (Central Processing Unit, CPU), a microprocessor or a microcontroller, for example an application-specific integrated circuit or a digital signal processor, possibly in combination with a memory unit for storing program commands, etc.

A computer program product, such as a computer program means, can be provided or supplied, for example, as a storage medium, such as a memory card, USB stick, CD-ROM, DVD, or else in the form of a downloadable file from a server in a network.

### BRIEF DESCRIPTION

Some of the embodiments will be described in detail, with references to the following Figures, wherein like designations denote like members, wherein:

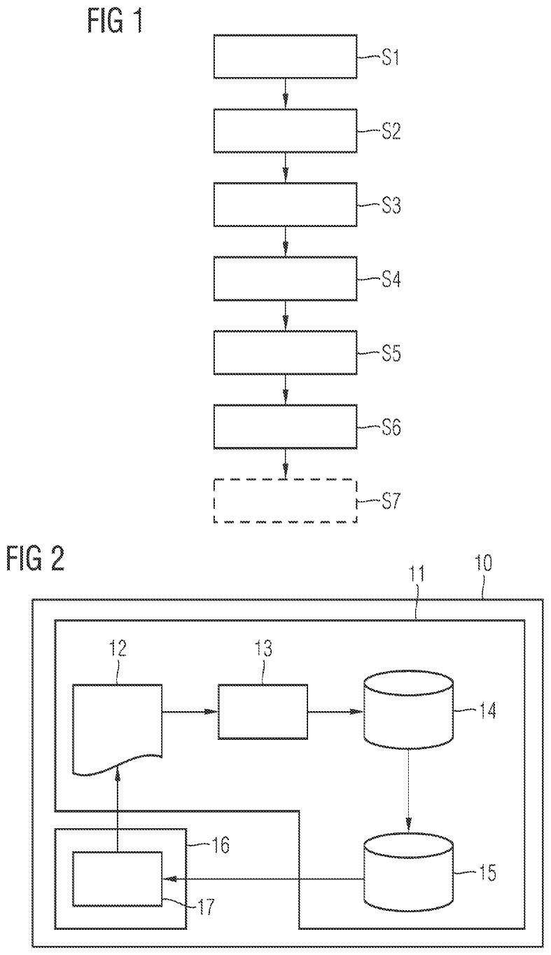

FIG. 1 shows an exemplary embodiment of the method as a flow diagram;

FIG. 2 shows a first exemplary embodiment of the system in a schematic representation; and

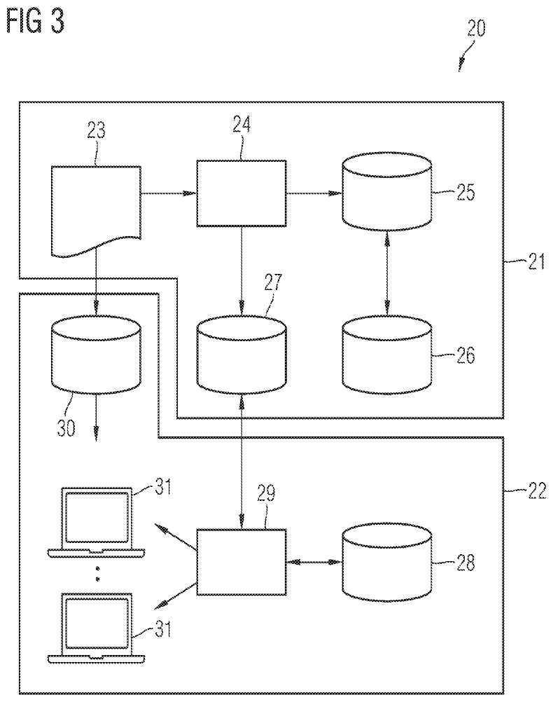

FIG. 3 shows a second exemplary embodiment of the system with automatic updating of the software image on further target computers in schematic representation.

### DETAILED DESCRIPTION

Software images may contain vulnerabilities that can be identified using analysis tools. However, a fundamental problem is an automatic exploitability check that determines whether the vulnerabilities can actually be used for an attack. This problem arises for all software images, but especially for container images, since a smooth transition from static analysis of the container image to dynamic verification of the exploitability is possible here.

FIG. 1 shows the individual method steps of the proposed method. For this purpose, all SW components of a SW image are identified in a first method step S1 and vulnerabilities in each identified SW component are determined by querying a vulnerability database, see method step S2. The vulnerability database stores already known vulnerabilities of SW components. The SW components and their vulnerabilities are for example identified or determined on a reference computer or on an assembly device of a manufacturer of the SW image. In method step S3, all exploits associated with the determined vulnerabilities of the identified software components are determined using an exploit database and associated with the software image in method step S4. It is assumed that at least one vulnerability is detected in the SW image and that the exploit database contains at least one exploit for each known SW vulnerability. For example, the exploits associated with the vulnerabilities can be queried by the vulnerability database on the exploit database.

The SW image and the exploits associated with the SW image are then executed on a runtime environment configuration specific to the target computer, see method step S5. If the execution of the exploit leads to an exploitability, i.e., if it enables unwanted access to the runtime environment, the exploitability is confirmed, see method step S6, and the confirmed exploitable vulnerability is reported to at least one user of the target computer and/or a manufacturer of the SW image, see S7.

By executing the exploits in the runtime environment of the software image, an exploitability of the vulnerability can be verified on exactly the one selected configuration of the runtime environment that is specific to the target machine. The at least one vulnerability confirmed to be exploitable is reported, for example, to all users of target computers whose target computers have the same configuration of the runtime environment. The user can then take measures, for example, to stop running the SW image and/or to install a modified, non-exploitable version of the SW image.

The at least one exploitable vulnerability is additionally or exclusively reported to the manufacturer or developer of the SW image. This will inform the manufacturer of an urgent need to eliminate the vulnerability or it can itself determine the urgency for the elimination of the vulnerability. A modified, non-exploitable SW image can be created depending on a policy that is stored in a manufacturer's assembly device, also called a build system, for assembling the SW image and depending on the at least one confirmed exploitable vulnerability. This newly created modified SW image is then provided to one or all target computers that have the specific configuration of the runtime environment. For example, the modified SW image is stored in a SW repository and can be retrieved from there by the target computer or automatically imported into the one or more target computers.

The analysis of the SW image for vulnerabilities and their exploitability can be carried out, for example, after a process of creating the SW image, in particular after the assembly of the SW image. As further vulnerabilities of the SW image are detected over time, the method steps are for example also carried out again for the same SW image at predetermined time intervals or after predetermined events, for example when a new vulnerability becomes known.

FIG. 2 shows a system 10 for the automatic analysis of SW images with regard to the exploitability of vulnerabilities on a target computer, which system is configured in such a way as to execute the described method. The system 10 comprises an analysis unit 11, and a test unit 16. The analysis unit 11 comprises a reference computer or an assembly device 12, which are designed so as to execute the SW image, and on which the individual SW components of the SW image can be identified and all vulnerabilities of each of the identified SW components can be determined. For this purpose, the analysis unit 11 comprises a component scanner 13, which identifies the SW components of the SW image. The analysis system 11 further comprises a vulnerability database 14 on which the vulnerabilities of the SW components are stored, and an exploit database 15 on which at least one exploit for each vulnerability is stored, with which the exploitability of the vulnerability on a SW image can be checked. The analysis unit 11 is designed to associate the determined exploits with the SW image.

The test unit 16 comprises a runtime environment 17, which corresponds to the configuration of a runtime environment of the target computer. The test unit 16 is designed to execute the SW image and the exploits associated with the SW image. If the execution of the exploits leads to the vulnerability being exploited on the test unit and the test unit 16 is vulnerable to attack via the vulnerability, for example, if it can be modified or controlled in an impermissible manner, the exploitability is reported by the test unit 16 to a user or a manufacturer of the SW image. For example, the test unit 16 comprises an output interface for this purpose.

Using a system 20 shown in FIG. 4, another exemplary embodiment of the method for automatic analysis of the exploitability is described, in which SW images are automatically checked for a plurality of target computers 31, for example, in a data network. The system 20 comprises an analysis unit 21 and a test unit 22 with a SW image 23 present in a reference computer or assembly device, having a component scanner 24, a vulnerability database 25, an exploit database 26, an image vulnerability database 27, an image vulnerability database 27, an inventory database 28, a configuration scanner 29 and a SW repository 30.

The SW image 23 of an SW application which comprises a plurality of SW components and is encapsulated as a container image or exists in a non-encapsulated form, is generated, for example, in an assembly device in a continuous integration and delivery process, also referred to as a CI/CD pipeline. The assembly device is not part of the system 20. After the SW image 23 is generated, the SW image 23 is installed on the analysis unit 21. The software components of the SW image 23 are identified using the component scanner 24. The component scanner 24 can be operated as a stand-alone unit or be integrated in the assembly device. The SW image 23 is provided to the component scanner 24 either centrally in an image repository, or locally. When identifying the SW components, additional manufacturing information, in particular a version identifier, is determined for the software components. The component scanner 24 thus creates a component list including the version of the component for the SW image 23. The SW components can be identified using a package manager within the SW image 23 or, for example, depending on a signature of the SW component.

Once the component list has been created, it is compared against the vulnerability database 25. The SW image is assigned the vulnerabilities it contains based on the identified SW components. The exploit database 26, which is optionally integrated into the vulnerability database 25, contains at least one exploit for each vulnerability, which contains information on how the vulnerability can be verified. The exploit includes, for example, a sequence of commands on the runtime environment or a query on an externally accessible interface.

On the basis of the detected vulnerabilities, the vulnerability scanner 24 writes a vulnerability profile assigned to the SW image and specific to the SW image, which comprises the identified SW components, the determined vulnerabilities and the determined exploits, to the image vulnerability database 27. The SW image-specific vulnerability profile can be saved in the image vulnerability database 27 at predetermined time intervals, e.g., cyclically or in an event-driven manner, for example on every SW image build within the CI/CD pipeline.

Different configurations of runtime environments are determined using an inventory database 28. The inventory database 28 stores information on which configurations of runtime environments operate which SW images 23 and how these can be accessed in the data network. A runtime environment is provided on a target computer. The inventory database also provides information on the target computers 31 that are operated with the respective configuration of the runtime environment, and how these can be accessed in the data network.

The inventory database 28 is kept up to date in two ways.

In one embodiment, the configuration of the runtime environment of the target computer 31 on which the SW image 23 is executed is determined by the target computer 31 and transmitted to an inventory database 28. This means that the underlying runtime environment of the target computer 31 reports the SW images active on this runtime environment using an additional module, for example a plugin or an agent operated on the system. The update can take place both periodically and in an event-driven manner, e.g., when starting or stopping a container instance from a container image.

In a further embodiment, the SW image 23 on a target computer 31 is identified by the configuration scanner 29, by the target computer 31 being identified externally by selectively performing actions. It is checked whether certain services are open or, for example, certain server strings are provided, for example during queries, or whether e.g., the MAC addresses and the manufacturer information encoded therein are evaluated. The configuration scanner 29 therefore determines the configuration of the runtime environment of the target computer depending on open services on the target computer 31, response messages of the target computer 31 to queries directed to the target computer 31, or an identifier of the target computer 31. The configuration scanner 29 has to find out, by specific tests following the exclusion procedure, which SW image will potentially be operated on a target computer 31.

Once the inventory database 28 with the associated SW images has been created, specific vulnerability tests can be carried out by the configuration scanner 29 periodically or upon the publication of critical vulnerabilities for each stored SW instance, i.e., container instance or conventional, unencapsulated software instance, and the associated SW image, which means it can be determined whether the vulnerabilities provided in the SW image are actually exposed, i.e., are being actively operated in the target computer. The target computer itself in this embodiment corresponds to the test unit, see test unit 16 in FIG. 2, on which the exploits are executed and thus it is checked whether the vulnerability is actually exploitable.

If it is determined that a vulnerability can be exploited, an alarm is triggered via a reporting/alarm component, for example in the target computer 31, and the result is sent back to the manufacturer of the SW image, in particular to a build component for the image. This provides the developer of the SW image either with feedback that the SW image contains vulnerability information in a specific configuration of the runtime environment and that this information can be exploited. Alternatively or additionally, an update of the SW image is triggered automatically, in which the identified SW component is updated by automatically applying a published patch to the one or more target computers 31. Furthermore, further recommended configuration changes identified with the vulnerability can be made to the runtime environment of the target computer or computers 31, or only the latest version can be installed on them.

If a new SW image version is provided, this can be provided in the SW repository, for example, and thus published, and it can be specifically ensured that affected runtime environments or target computers 31 will be supplied with the new SW image version without vulnerabilities as a priority.

The described method and system allow vulnerabilities to be identified not only on the basis of the SW image, but also to be verified on the runtime environment by targeted tests on externally exposed services. The developer can be informed by the configuration scanner 29 as to which target computers 31 are to be supplied with new SW images as a priority. Automatic builds can generate new SW images by selectively implementing recommended measures, such as importing a newer software version. In the case of target computers that contain particularly critical SW images, it is possible to determine which target computers are to be patched, i.e., updated, as a priority by installing a new SW image.

Although the present invention has been disclosed in the form of embodiments and variations thereon, it will be understood that numerous additional modifications and variations could be made thereto without departing from the scope of the invention.

For the sake of clarity, it is to be understood that the use of “a” or “an” throughout this application does not exclude a plurality, and “comprising” does not exclude other steps or elements.

1. A method for automatic analysis of an exploitability of vulnerabilities of a software image executed on a target computer, comprising:
identifying all the software components contained in the software image;
determining vulnerabilities of an identified software component for each software component of the software image using a vulnerability database;
determining all exploits associated with an at least one determined vulnerability of the software component, for each identified software component, using an exploit database,
associating the determined exploits with the software image; and
executing (S5) the software image and the exploit associated with the software image on a configuration of a runtime environment specific to the target computer; and
confirming the exploitability of the at least one identified vulnerability on the configuration of the runtime environment if an execution of the at least one exploit leads to exploitation of the vulnerability,
wherein a modified, non-exploitable software image is created depending on a policy stored in a manufacturer's assembly device for assembling the software image and depending on the at least one confirmed exploitable vulnerability, and the modified software image is provided to one or all of the target computers that have the specific configuration of the runtime environment.

2. The method as claimed in claim 1, wherein the at least one exploitable vulnerability is reported to a user of the target computer and/or to a manufacturer of the software image.

3. The method as claimed in claim 1, wherein the method steps are carried out after assembly of the software image at the manufacturer and/or at predetermined time intervals and/or after predetermined events.

4. The method as claimed in claim 1, wherein the modified software image is provided on a software repository.

5. The method as claimed in claim 1, wherein the modified software image is retrieved by the target computer or automatically imported into the target computer.

6. The method as claimed in claim 1, wherein the modified software image is automatically imported into further target computers with the same configuration of the runtime environment.

7. The method as claimed in claim 1, wherein the software components and vulnerabilities are identified on a reference computer or on a manufacturer's assembly device.

8. The method as claimed in claim 1, wherein the software components are identified depending on a signature of the software component or by a package manager within the software image.

9. The method as claimed claim 1, wherein additional manufacturing information, including a version identifier, is determined for the at least one identified software components.

10. The method as claimed in claim 1, wherein a vulnerability profile specific to the software image and comprising the identified software components, the determined vulnerabilities and the determined exploits, is stored on an image vulnerability database.

11. The method as claimed in claim 1, wherein different configurations of runtime environments, with the correspondingly configured target computers on which the software image is executed, are determined by an inventory database.

12. The method as claimed in claim 11, wherein the configuration of the runtime environment of the target computer, on which the software image is executed, is determined by the target computer and transmitted to an inventory database.

13. The method as claimed in claim 11, wherein the configuration of the runtime environment of the target computer, on which the software image is executed, is determined by a configuration scanner and transmitted to the inventory database.

14. The method as claimed in claim 13, wherein the configuration scanner determines the configuration of the runtime environment of the target computer depending on open services on the target computer, response messages of the target computer to queries directed to the target computer, or an identifier of the target computer.

15. A system for automatic analysis of an exploitability of vulnerabilities of a software image executed on a target computer, comprising:
an analysis unit, which is configured to:
identify all software components contained in the software image,
determine vulnerabilities of an identified software component for each software component of the software image using a vulnerability database,
determine all exploits associated with at least one determined vulnerability of the software component, for each identified software component, using an exploit database,
associate the determined exploits with the software image, and
a test unit, which is configured to:
execute the software image and the exploit associated with the software image on a configuration of a runtime environment specific to the target computer,
confirm the exploitability of the at least one identified vulnerability on the configuration of the runtime environment if an execution of the at least one exploit leads to exploitation of the vulnerability;
wherein a modified, non-exploitable software image is created depending on a policy stored in a manufacturer's assembly device for assembling the software image and depending on the at least one confirmed exploitable vulnerability, and the modified software image is provided to one or all of the target computers that have the specific configuration of the runtime environment.

16. A computer program product, comprising a computer readable hardware storage device having computer readable program code stored therein, said program code executable by a processor of a computer system to implement a method, as claimed in claim 1.
